(19) United States
(12) Patent Application Publication
(10) Pub. No.: US 2025/0046341 A1
(43) Pub. Date: Feb. 6, 2025

(54) RECORDING MEDIUM, METHOD FOR RECORDING INFORMATION, AND METHOD FOR READING INFORMATION

(71) Applicant: Panasonic Intellectual Property Management Co., Ltd., Osaka (JP)

(72) Inventors: KOTA ANDO, Osaka (JP); MASAKO YOKOYAMA, Osaka (JP); NAOYA SAKATA, Osaka (JP); KENJI TAGASHIRA, Osaka (JP); HIDEKAZU ARASE, Hyogo (JP)

(21) Appl. No.: 18/925,142

(22) Filed: Oct. 24, 2024

Related U.S. Application Data
(63) Continuation of application No. PCT/JP2023/012103, filed on Mar. 27, 2023.

(30) Foreign Application Priority Data
May 17, 2022 (JP) 2022-080838

(51) Int. Cl. G11B 7/2437; C08G 61/12

(52) U.S. Cl. CPC G11B 7/2437; C08G 61/121; C08G 61/124; C08G 2261/12; C08G 2261/57

(57) ABSTRACT

A recording medium of an aspect of the present disclosure includes a recording layer containing a polymer P. The polymer P contains a group G having nonlinear light absorption characteristics and has a glass transition temperature of higher than or equal to 200° C. A method for recording information of an aspect of the present disclosure includes preparing a light source emitting light having a wavelength of longer than or equal to 390 nm and shorter than or equal to 420 nm and focusing the light from the light source and applying the light to the recording layer of the recording medium.

### BACKGROUND

### 1. Technical Field

The present disclosure relates to a recording medium, a method for recording information, and a method for reading information.

### 2. Description of the Related Art

As a technique for increasing the recording capacity of optical information recording media, three-dimensional recording is known, which records information in a multilayered body. In the field of three-dimensional recording, to improve recording density, a finer focus spot is required to be achieved. From the viewpoint of the diffraction limit of focused laser light, to achieve a finer focus spot, laser light having a short wavelength is used. Examples of this laser light include laser light having a central wavelength of 405 nm, which is the standard of Blu-ray (registered trademark) Disc. Thus, optical recording media using the laser light having a central wavelength of 405 nm are known.

Recording media include, for example, a recording layer containing dye. Japanese Patent No. 6448042 and Harry L. Anderson et al, “Two-Photon Absorption and the Design of Two-Photon Dyes”, Angew. Chem. Int. Ed. 2009, Vol. 48, p. 3244-3266. exemplify dyes that can be utilized for recording media. Japanese Patent No. 6448042 in particular discloses an optical information recording material in which a nonlinear light absorption dye such as pyrene is dispersed in resin. In Japanese Patent No. 6448042, the optical recording medium including the recording layer containing the optical information recording material can perform hologram recording.

### SUMMARY

A new recording medium containing a nonlinear light absorption material is being demanded.

In one general aspect, the techniques disclosed here feature a recording medium including a recording layer containing a polymer, wherein the polymer contains a group having nonlinear light absorption characteristics and has a glass transition temperature of higher than or equal to 200° C.

The present disclosure provides a new recording medium containing a nonlinear light absorption material.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view of a schematic configuration of a recording medium according to an embodiment of the present disclosure;

FIG. 2A is a flowchart about a method for recording information using the recording medium according to the embodiment of the present disclosure;

FIG. 2B is a flowchart about a method for reading information using the recording medium according to the embodiment of the present disclosure; and

FIG. 3 is a graph of record reproduction characteristics of recording media of examples and comparative examples.

### DETAILED DESCRIPTIONS

### Underlying Knowledge Forming Basis of the Present Disclosure

In a recording medium including a plurality of recording layers, when single-photon absorption in each recording layer is large for light utilized for performing recording of information or reading of information, the intensity of the light decreases as the light passes through each recording layer. In this case, there is a tendency that the sensitivity of recording and reading significantly decreases in a recording layer disposed at a position apart from a light source. Thus, there is a demand for a recording layer having small single-photon absorption against the light utilized for performing recording of information or reading of information. In the present specification, reading of information may be called reproduction of information. Single-photon absorption may be called linear light absorption.

To more increase the number of recording layers in the recording medium, there is a need to decrease linear light absorption per recording layer and to minimize effects by other recording layers other than a recording layer in which recording or reading is performed. To decrease linear light absorption per recording layer, studies have been conducting on recording layers containing dyes having almost no linear light absorption bands and having a nonlinear optical effect for the light utilized for performing recording or reproduction.

The nonlinear optical effect means that when strong light such as laser light is applied to a substance, an optical phenomenon proportional to the square or a higher order than the square of the electric field of the applied light occurs in the substance. Examples of the optical phenomenon include absorption, reflection, scattering, and emission. Examples of a second-order nonlinear optical effect, which is proportional to the square of the electric field of the applied light, include second harmonic generation (SHG), the Pockels effect, and the parametric effect. Examples of a third-order nonlinear optical effect, which is proportional to the cube of the electric field of the applied light, include multiphoton absorption such as two-photon absorption, third harmonic generation (THG), and the Kerr effect. In recording media including a plurality of recording layers in particular, multiphoton absorption such as two-photon absorption can be utilized. In the present specification, multiphoton absorption such as two-photon absorption may be called nonlinear light absorption. A material that can undergo nonlinear light absorption may be called a nonlinear light absorption material. Nonlinear light absorption may be called nonlinear absorption.

As nonlinear optical materials, inorganic materials, from which single crystals can be easily prepared, have been so far developed. Meanwhile, in recent years, development of nonlinear optical materials containing organic materials has been expected. Organic materials not only have a higher degree of freedom of design but also have larger nonlinear optical constants than those of inorganic materials. Furthermore, in organic materials, nonlinear response is performed at high speed.

In compound constituting organic materials, there is a tendency that the closer the wavelength for causing an electron to transition from the ground state to the lowest singlet excited state is to the excitation wavelength of multiphoton absorption, the more improve the multiphoton absorption characteristics of the organic material, thus, for example, achieving a larger two-photon absorption cross section. In recording media, normally, light having the same wavelength as the excitation wavelength of multiphoton absorption is utilized for performing recording or reproduction. Based on this design policy, various compounds are being synthesized. In the present specification, in a compound, the transition of an electron from the ground state to the lowest singlet excited state may be called S₀-S₁ transition. Note that the two-photon absorption cross section is an indicator indicting the efficiency of two-photon absorption. The unit of the two-photon absorption cross section is GM (10⁻⁵⁰ cm⁴·s·molecule⁻¹·photon⁻¹).

### SUMMARY OF ASPECT ACCORDING TO PRESENT DISCLOSURE

A recording medium according to a first aspect of the present disclosure includes a recording layer containing a polymer, wherein
the polymer contains a group having nonlinear light absorption characteristics and has a glass transition temperature of higher than or equal to 200° C.

According to the first aspect, a new recording medium containing a nonlinear light absorption material can be provided.

In a second aspect of the present disclosure, for example, in the recording medium according to the first aspect, a transmittance of light with a wavelength of 405 nm in the recording layer may be greater than or equal to 95%.

In a third aspect of the present disclosure, for example, in the recording medium according to the first or second aspect, a refractive index of the recording layer may be greater than or equal to 1.65.

The recording medium according to the second or third aspect tends to have good record reproduction characteristics.

In a fourth aspect of the present disclosure, for example, in the recording medium according to any one of the first to third aspects, the polymer may have at least one selected from the group consisting of a carbazole skeleton and a naphthalene skeleton in a side chain.

The polymer described in the fourth aspect easily raises the refractive index and the glass transition temperature while maintaining the transmittance of light with a wavelength in a range of 390 nm to 420 nm. This polymer has appropriate solubility to a solvent, and thus a coating method for producing a recording layer by applying a coating liquid is easily used.

In a fifth aspect of the present disclosure, for example, in the recording medium according to any one of the first to fourth aspects, the polymer may contain at least one selected from the group consisting of a structural unit derived from styrenes and a structural unit derived from stilbenes.

The polymer described in the fifth aspect easily adjusts the transmittance of the light with a wavelength in a range of 390 nm to 420 nm, the refractive index, and the glass transition temperature to high values. This polymer also tends to have appropriate solubility to a solvent. Furthermore, a group having nonlinear light absorption characteristics is easily introduced to the structural unit derived from styrenes or stilbenes.

In a sixth aspect of the present disclosure, for example, in the recording medium according to any one of the first to fifth aspects, the polymer may contain at least one selected from the group consisting of a structural unit A represented by Formula (1) below, a structural unit B represented by Formula (2) below, and a structural unit C represented by Formula (3) below:

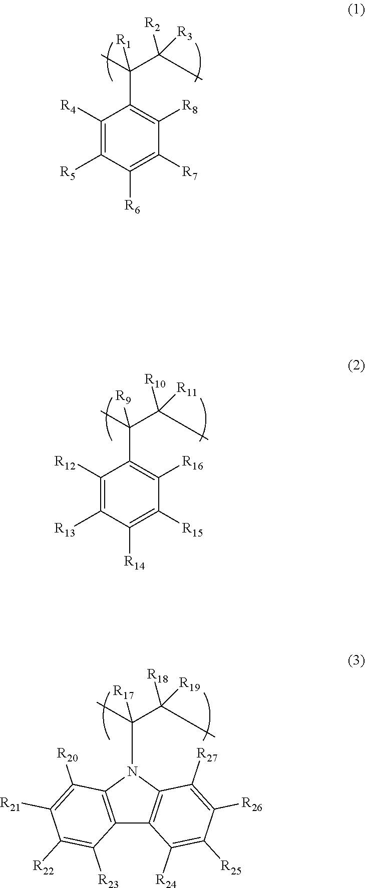

wherein in Formula (1) above, R₁ to R₈ mutually independently contain at least one atom selected from the group consisting of H, B, C, N, O, F, Si, P, S, Cl, Br, and I; and
at least one selected from the group consisting of R₄ to R₈ contains a group having nonlinear light absorption characteristics,
in Formula (2) above, R₉ to R₁₆ are mutually independently a group containing at least one atom selected from the group consisting of H, B, C, N, O, F, Si, P, S, Cl, Br, and I and other than a group having nonlinear light absorption characteristics, and
in Formula (3) above, R₁₇ to R₂₇ mutually independently contain at least one atom selected from the group consisting of H, B, C, N, O, F, Si, P, S, Cl, Br, and I.

The polymer described in the sixth aspect easily adjusts the transmittance of light, the refractive index, and the glass transition temperature to high values. This polymer is given nonlinear light absorption characteristics by the structural unit A.

In a seventh aspect of the present disclosure, for example, in the recording medium according to the sixth aspect, in the polymer, a number x of the structural unit A, a number y of the structural unit B, and a number z of the structural unit C may satisfy 0.35≤z/(x+y+z).

The polymer described in the seventh aspect easily adjusts the refractive index of the recording layer to greater than or equal to 1.65.

In an eighth aspect of the present disclosure, for example, in the recording medium according to the sixth or seventh aspect, in the polymer, a number x of the structural unit A, a number y of the structural unit B, and a number z of the structural unit C may satisfy 0.07≤x/(x+y+z)≤0.65.

The polymer described in the eighth aspect easily adjusts the refractive index of the recording layer to greater than or equal to 1.65. Furthermore, this polymer tends to have an appropriate nonlinear light absorption amount. Thus, the recording medium having this polymer tends to show good recording sensitivity.

In a ninth aspect of the present disclosure, for example, in the recording medium according to any one of the sixth to eighth aspects, in Formula (1) above, at least one selected from the group consisting of R₄ to R₈ may be represented by Formula (4) below:

-L-R_{A} (4)
wherein in Formula (4) above, L is a linking group containing at least one atom selected from the group consisting of C, N, O, and S; and R_{A} is a group having a pyrene skeleton.

The polymer described in the ninth aspect easily achieves a good nonlinear light absorption amount while adjusting the transmittance of light, the refractive index, and the glass transition temperature to high values. This polymer also tends to have appropriate solubility to a solvent. The recording layer having this polymer tends to show good record reproduction characteristics and good thermal stability.

A method for recording information according to a 10th aspect of the present disclosure includes:
preparing a light source emitting light having a wavelength of longer than or equal to 390 nm and shorter than or equal to 420 nm; and
focusing the light from the light source and applying the light to the recording layer of the recording medium according to any one of the first to ninth aspects.

The 10th aspect can record information in the recording medium with high recording density.

A method for reading information according to an 11th aspect of the present disclosure is, for example, a method for reading information recorded by the method of recording according to the 10th aspect, the method of reading including:
measuring an optical characteristic of the recording layer by applying light to the recording layer of the recording medium; and
reading information from the recording layer.

The 11th aspect can easily read information from the recording medium.

A composition according to a 12th aspect of the present disclosure has a polymer containing at least one selected from the group consisting of a structural unit A represented by Formula (1) below, a structural unit B represented by Formula (2) below, and a structural unit C represented by Formula (3) below:

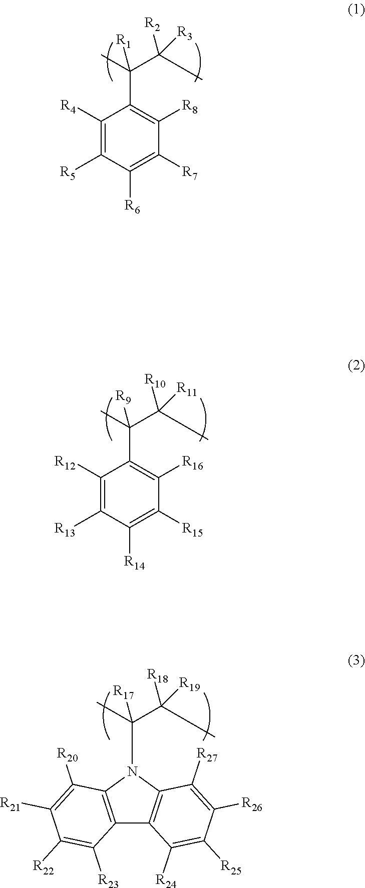

wherein in Formula (1) above, R₁ to R₈ mutually independently contain at least one atom selected from the group consisting of H, B, C, N, O, F, Si, P, S, Cl, Br, and I; and
at least one selected from the group consisting of R₄ to R₈ contains a group having nonlinear light absorption characteristics,
in Formula (2) above, R₉ to R₁₆ are mutually independently a group containing at least one atom selected from the group consisting of H, B, C, N, O, F, Si, P, S, Cl, Br, and I and other than a group having nonlinear light absorption characteristics, and
in Formula (3) above, R₁₇ to R₂₇ mutually independently contain at least one atom selected from the group consisting of H, B, C, N, O, F, Si, P, S, Cl, Br, and I.

The 12th aspect can provide a new composition suitable for a material of a recording layer of a recording medium.

The following describes an embodiment of the present disclosure with reference to the accompanying drawings. The present disclosure is not limited to the following embodiment.

### EMBODIMENT

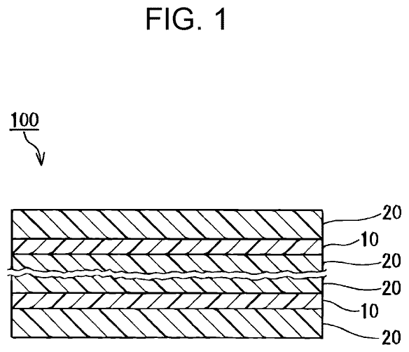

FIG. 1 is a sectional view of a schematic configuration of a recording medium 100 according to the embodiment of the present disclosure. As illustrated in FIG. 1, the recording medium 100 includes a recording layer 10. The recording layer 10 contains a polymer P. The polymer P contains a group G having nonlinear light absorption characteristics and has a glass transition temperature of higher than or equal to 200° C.

The recording medium 100 may include a plurality of recording layers 10. The recording layers 10 are arranged, for example, in the thickness direction of the recording medium 100. In the recording medium 100, the number of the recording layers 10, which is not particularly limited, is, for example, greater than or equal to 2 and less than or equal to 1,000. The recording medium 100 including the recording layers 10 functions as a three-dimensional optical memory. A specific example of the recording medium 100 is a three-dimensional optical disc.

The recording medium 100 further includes, for example, a dielectric layer 20 positioned between two recording layers 10. In the present specification, the dielectric layer 20 may be called an intermediate layer. The recording medium 100 may include a plurality of dielectric layers 20. In the recording medium 100, the recording layers 10 and the dielectric layers 20 may be alternately arranged. In other words, the recording layers 10 and the dielectric layers 20 may be alternately stacked on each other. As an example, the recording layers 10 are each disposed between two dielectric layers 20 and are in direct contact with each of the two dielectric layers 20. In the recording medium 100, the number of the dielectric layers 20, which is not particularly limited, is, for example, greater than or equal to 3 and less than or equal to 1,001. The dielectric layer 20 can function as, for example, a dielectric layer.

### Recording Layer

As described above, the recording layer 10 contains the polymer P. The polymer P contains the group G having nonlinear light absorption characteristics. As an example, the polymer P has the group G in a side chain. Whether a group contained in the polymer P has nonlinear light absorption characteristics can be determined by the following method. First, a compound having the same structure as that of the group contained in the polymer P is prepared. About this compound, light absorption characteristics are measured to identify whether it has nonlinear light absorption characteristics. When this compound has nonlinear light absorption characteristics, it can be determined that the group contained in the polymer P also has nonlinear light absorption characteristics. Note that it can also be determined that the polymer P contains the group G having nonlinear light absorption characteristics when the polymer P itself has nonlinear light absorption characteristics.

The polymer P contains the group G having nonlinear light absorption characteristics, and thus the polymer P functions as a nonlinear light absorption material. In the recording layer 10 containing the nonlinear light absorption material, there is a tendency that linear light absorption at a record reproduction wavelength is small, and recording sensitivity is good. When linear light absorption at the record reproduction wavelength is small in the recording layer 10, when recording or reproduction processing on the recording medium 100 is performed, another adjacent recording layer 10 is less affected. Thus, the recording layer 10 containing the polymer P is suitable for the recording medium 100 having a multilayer structure.

Examples of the group G having nonlinear light absorption characteristics include groups containing at least one selected from the group consisting of a carbon-carbon double bond, a carbon-carbon triple bond, and an aromatic ring. Specific examples of the group G include a group having a pyrene skeleton, a group having a diphenylacetylene skeleton, and a group having a stiff-stilbene skeleton.

Specifically, the polymer P contains a structural unit A having the group G. Examples of the structural unit A include a structural unit A1 derived from styrenes and having the group G and a structural unit A2 derived from stilbenes and having the group G. In the present specification, the structural unit A1 may be simply called the structural unit A1 derived from styrenes. The structural unit A2 may be simply called the structural unit A2 derived from stilbenes. The polymer P contains, for example, at least one structural unit A selected from the group consisting of the structural unit A1 derived from styrenes and the structural unit A2 derived from stilbenes. The polymer P may contain the structural unit A1 derived from styrenes.

The structural unit A is represented by, for example, Formula (1) below:

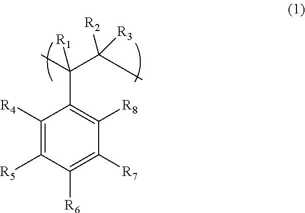

In Formula (1), R₁ to R₈ mutually independently contain at least one atom selected from the group consisting of H, B, C, N, O, F, Si, P, S, Cl, Br, and I. At least one selected from the group consisting of R₄ to R₈ contains the group G having nonlinear light absorption characteristics.

R₁ to R₈ may be mutually independently a hydrogen atom, a halogen atom, a hydrocarbon group, a halogenated hydrocarbon group, a group containing an oxygen atom, a group containing a nitrogen atom, a group containing a sulfur atom, a group containing a silicon atom, a group containing a phosphorus atom, or a group containing a boron atom. At least one selected from the group consisting of R₄ to R₈ may be a group in which the group G having nonlinear light absorption characteristics replaces a hydrocarbon group, a halogenated hydrocarbon group, a group containing an oxygen atom, a group containing a nitrogen atom, a group containing a sulfur atom, a group containing a silicon atom, a group containing a phosphorus atom, or a group containing a boron atom.

Examples of the halogen atom include F, Cl, Br, and I. In the present specification, the halogen atom may be called a halogen group.

The number of carbon atoms of the hydrocarbon group, which is not particularly limited, is, for example, greater than or equal to 1 and less than or equal to 10 and may be greater than or equal to 1 and less than or equal to 8 or greater than or equal to 1 and less than or equal to 5. The hydrocarbon group may be linear, branched, or cyclic.

Examples of the hydrocarbon group include an aliphatic saturated hydrocarbon group, an alicyclic hydrocarbon group, and an aliphatic unsaturated hydrocarbon group. The aliphatic saturated hydrocarbon group may be an alkyl group. Examples of the aliphatic saturated hydrocarbon group include —CH₃, —CH₂CH₃, —CH₂CH₂CH₃, —CH(CH₃)₂, —CH(CH₃)CH₂CH₃, —C(CH₃)₃, —CH₂CH(CH₃)₂, —(CH₂)₃CH₃, —(CH₂)₄CH₃, —C(CH₂CH₃)(CH₃)₂, —CH₂C(CH₃)₃, —(CH₂)₅CH₃, —(CH₂)₆CH₃, —(CH₂)₇CH₃, —(CH₂)₈CH₃, and —(CH₂)₉CH₃. Examples of the alicyclic hydrocarbon group include a cyclopropyl group, a cyclobutyl group, a cyclopentyl group, and a cyclohexyl group. Examples of the aliphatic unsaturated hydrocarbon group include —CH═CH₂, —C≡CH, —C≡CCH₃, —C(CH₃)═CH₂, —CH═CHCH₃, and —CH₂CH═CH₂.

The halogenated hydrocarbon group means a group in which at least one hydrogen atom contained in a hydrocarbon group is replaced by a halogen atom. The halogenated hydrocarbon group may be a group in which all the hydrogen atoms contained in the hydrocarbon group may be replaced by halogen atoms. Examples of the halogenated hydrocarbon group include a halogenated alkyl group and a halogenated alkenyl group.

Examples of the halogenated alkyl group include —CF₃, —CH₂F, —CH₂Br, —CH₂Cl, —CH₂I, and —CH₂CF₃. Examples of the halogenated alkenyl group include —CH═CHCF₃.

The group containing an oxygen atom is, for example, a substituent having at least one selected from the group consisting of a hydroxy group, a carboxy group, an aldehyde group, an ether group, an acyl group, and an ester group.

Examples of the substituent having a hydroxy group include a hydroxy group itself and a hydrocarbon group having a hydroxy group. Examples of the hydrocarbon group having a hydroxy group include —CH₂OH, —CH(OH)CH₃, —CH₂CH(OH)CH₃, and —CH₂C(OH)(CH₃)₂.

Examples of the substituent having a carboxy group include a carboxy group itself and a hydrocarbon group having a carboxy group. Examples of the hydrocarbon group having a carboxy group include —CH₂CH₂COOH and —C(COOH)(CH₃)₂.

Examples of the substituent having an aldehyde group include an aldehyde group itself and a hydrocarbon group having an aldehyde group. Examples of the hydrocarbon group having an aldehyde group include —CH═CHCHO.

Examples of the substituent having an ether group include an alkoxy group, a halogenated alkoxy group, an alkenyloxy group, an oxiranyl group, and a hydrocarbon group having at least one of these functional groups. At least one hydrogen atom contained in the alkoxy group may be replaced by a group containing at least one atom selected from the group consisting of N, O, P, and S. Examples of the alkoxy group include a methoxy group, an ethoxy group, a 2-methoxyethoxy group, a butoxy group, a 2-methylbutoxy group, a 2-methoxybutoxy group, a 4-ethylthiobutoxy group, a pentyloxy group, a hexyloxy group, a heptyloxy group, an octyloxy group, a nonyloxy group, and a decyloxy group. Examples of the halogenated alkoxy group include —OCHF₂, —OCH₂F, and —OCH₂Cl. Examples of the alkenyloxy group include —OCH═CH₂. Examples of the hydrocarbon group having a functional group such as an alkoxy group include —CH₂OCH₃, —C(OCH₃)₃, a 2-methoxybutyl group, and a 6-methoxyhexyl group.

Examples of the substituent having an acyl group include an acyl group itself and a hydrocarbon group having an acyl group. Examples of the acyl group include —COCH₃. Examples of the hydrocarbon group having an acyl group include —CH═CHCOCH₃.

Examples of the substituent having an ester group include an alkoxycarbonyl group, an acyloxy group, and a hydrocarbon group having at least one of these functional groups. Examples of the alkoxycarbonyl group include —COOCH₃, —COO(CH₂)₃CH₃, and —COO(CH₂)₇CH₃. Examples of the acyloxy group include —OCOCH₃. Examples of the hydrocarbon group having a functional group such as an acyloxy group include —CH₂OCOCH₃.

The group containing a nitrogen atom is, for example, a substituent having at least one selected from the group consisting of an amino group, an imino group, a cyano group, an amide group, a carbamate group, a nitro group, a cyanamide group, an isocyanate group, and an oxime group.

Examples of the substituent having an amino group include a primary amino group, a secondary amino group, a tertiary amino group, and a hydrocarbon group having at least one of these functional groups. Examples of the tertiary amino group include —N(CH₃)₂. Examples of the hydrocarbon group having a functional group such as a primary amino group include —CH₂NH₂, —CH₂N(CH₃)₂, and —(CH₂)₄N(CH₃)₂.

Examples of the substituent having an imino group include an imino group itself and a hydrocarbon group having an imino group. Examples of the imino group include —N═CCl₂.

Examples of the substituent having a cyano group include a cyano group itself and a hydrocarbon group having a cyano group. Examples of the hydrocarbon group having a cyano group include —CH₂CN and —CH═CHCN.

Examples of the substituent having an amide group include an amide group itself and a hydrocarbon group having an amide group. Examples of the amide group include —CONH₂, —NHCHO, —NHCOCH₃, —NHCOCF₃, —NHCOCH₂Cl, and —NHCOCH(CH₃)₂. Examples of the hydrocarbon group having an amide group include —CH₂CONH₂ and —CH₂NHCOCH₃.

Examples of the substituent having a carbamate group include a carbamate group itself and a hydrocarbon group having a carbamate group. Examples of the carbamate group include —NHCOOCH₃, —NHCOOCH₂CH₃, and —NHCO₂(CH₂)₃CH₃.

Examples of the substituent having a nitro group include a nitro group itself and a hydrocarbon group having a nitro group. Examples of the hydrocarbon group having a nitro group include —C(NO₂)(CH₃)₂.

Examples of the substituent having a cyanamide group include a cyanamide group itself and a hydrocarbon group having a cyanamide group. The cyanamide group is represented by —NHCN.

Examples of the substituent having an isocyanate group include an isocyanate group itself and a hydrocarbon group having an isocyanate group. The isocyanate group is represented by —N═C═O.

Examples of the substituent having an oxime group include an oxime group itself and a hydrocarbon group having an oxime group. The oxime group is represented by —CH═NOH.

The group containing a sulfur atom is, for example, a substituent having at least one selected from the group consisting of a thiol group, a sulfide group, a sulfinyl group, a sulfonyl group, a sulfino group, a sulfonic acid group, an acylthio group, a sulfenamide group, a sulfonamide group, a thioamide group, a thiocarbamide group, and a thiocyano group.

Examples of the substituent having a thiol group include a thiol group itself and a hydrocarbon group having a thiol group. The thiol group is represented by —SH.

Examples of the substituent having a sulfide group include an alkylthio group, an alkyldithio group, an alkenylthio group, an alkynylthio group, a thiacyclopropyl group, and a hydrocarbon group having at least one of these functional groups. At least one hydrogen atom contained in the alkylthio group may be replaced by a halogen group. Examples of the alkylthio group include —SCH₃, —S(CH₂)F, —SCH(CH₃)₂, and —SCH₂CH₃. Examples of the alkyldithio group include —SSCH3. Examples of the alkenylthio group include —SCH═CH₂ and —SCH₂CH═CH₂. Examples of the alkynylthio group include —SC≡CH. Examples of the hydrocarbon group having a functional group such as an alkylthio group include —CH₂SCF₃.

Examples of the substituent having a sulfinyl group include a sulfinyl group itself and a hydrocarbon group having a sulfinyl group. Examples of the sulfinyl group include —SOCH₃.

Examples of the substituent having a sulfonyl group include a sulfonyl group itself and a hydrocarbon group having a sulfonyl group. Examples of the sulfonyl group include —SO₂CH₃. Examples of the hydrocarbon group having a sulfonyl group include —CH₂SO₂CH₃ and —CH₂SO₂CH₂CH₃.

Examples of the substituent having a sulfino group include a sulfino group itself and a hydrocarbon group having a sulfino group.

Examples of the substituent having a sulfonic acid group include a sulfonic acid group itself and a hydrocarbon group having a sulfonic acid group.

Examples of the substituent having an acylthio group include an acylthio group itself and a hydrocarbon group having an acylthio group. Examples of the acylthio group include —SCOCH₃.

Examples of the substituent having a sulfenamide group include a sulfenamide group itself and a hydrocarbon group having a sulfenamide group. Examples of the sulfenamide group include —SN(CH₃)₂.

Examples of the substituent having a sulfonamide group include a sulfonamide group itself and a hydrocarbon group having a sulfonamide group. Examples of the sulfonamide group include —SO₂NH₂ and —NHSO₂CH₃.

Examples of the substituent having a thioamide group include a thioamide group itself and a hydrocarbon group having a thioamide group. Examples of the thioamide group include —NHCSCH₃.

Examples of the substituent having a thiocarbamide group include a thiocarbamide group itself and a hydrocarbon group having a thiocarbamide group. Examples of the thiocarbamide group include —NHCSNHCH₂CH₃.

Examples of the substituent having a thiocyano group include a thiocyano group itself and a hydrocarbon group having a thiocyano group. Examples of the hydrocarbon group having a thiocyano group include —CH₂SCN.

The group containing a silicon atom is, for example, a substituent having at least one selected from the group consisting of a silyl group and a siloxy group.

Examples of the substituent having a silyl group include a silyl group itself and a hydrocarbon group having a silyl group. Examples of the silyl group include —Si(CH₃)₃, —SiH(CH₃)₂, —Si(OCH₃)₃, —Si(OCH₂CH₃)₃, —SiCH₃(OCH₃)₂, —Si(CH₃)₂OCH₃, —Si(N(CH₃)₂)₃, —SiF(CH₃)₂, —Si(OSi(CH₃)₃)₃, and —Si(CH₃)₂OSi(CH₃)₃. Examples of the hydrocarbon group having a silyl group include —(CH₂)₂Si(CH₃)₃.

Examples of the substituent having a siloxy group include a siloxy group itself and a hydrocarbon group having a siloxy group. Examples of the hydrocarbon group having a siloxy group include —CH₂OSi(CH₃)₃.

The group containing a phosphorus atom is, for example, a substituent having at least one selected from the group consisting of a phosphino group and a phosphoryl group.

Examples of the substituent having a phosphino group include a phosphino group itself and a hydrocarbon group having a phosphino group. Examples of the phosphino group include —PH₂, —P(CH₃)₂, —P(CH₂CH₃)₂, —P(C(CH₃)₃)₂, and —P(CH(CH₃)₂)₂.

Examples of the substituent having a phosphoryl group include a phosphoryl group itself and a hydrocarbon group having a phosphoryl group. Examples of the hydrocarbon group having a phosphoryl group include —CH₂PO(OCH₂CH₃)₂.

The group containing a boron atom is, for example, a substituent having a boronic acid group. Examples of the substituent having a boronic acid group include a boronic acid group itself and a hydrocarbon group having a boronic acid group.

In at least one selected from the group consisting of R₄ to R₈, when the group G having nonlinear light absorption characteristics is bonded to a benzene ring adjacent to R₄ to R₈, the conjugated system of the group G may extend, and its electronic state may change. Thus, a linking group such as an alkylene group may be provided between the group G and the benzene ring adjacent to R₄ to R₈.

In Formula (1), at least one selected from the group consisting of R₄ to R₈ may be represented by Formula (4) below:

-L-R_{A} (4)

In Formula (4), L is a linking group containing at least one atom selected from the group consisting of C, N, O, and S. L does not include, for example, a bond affecting a conjugated system such as a carbon-carbon double bond. L may contain an ether group and may be —CH₂—O—CH₂—. L may be an alkylene group.

R_{A} is, for example, the group G having nonlinear light absorption characteristics and may be a group having a pyrene skeleton. R_{A} may be represented by Formula (4A) below:

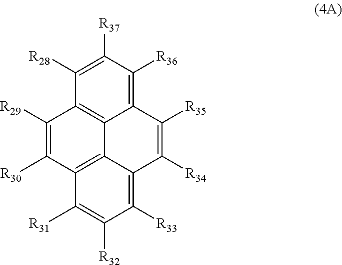

In Formula (4A), R₂₈ to R₃₇ mutually independently contain at least one atom selected from the group consisting of H, B, C, N, O, F, Si, P, S, Cl, Br, and I. One among R₂₈ to R₃₇ is bonded to L in Formula (4) above. L in Formula (4) may be directly bonded to the pyrene ring represented by Formula (4A) at one position among R₂₈ to R₃₇.

R₂₈ to R₃₇ may be mutually independently a hydrogen atom, a halogen atom, a hydrocarbon group, a halogenated hydrocarbon group, a group containing an oxygen atom, a group containing a nitrogen atom, a group containing a sulfur atom, a group containing a silicon atom, a group containing a phosphorus atom, or a group containing a boron atom. Examples of these groups include those described above for R₁ to R₈.

Specific examples of the structural unit A include a structural unit A-1 represented by Formula (A-1) below:

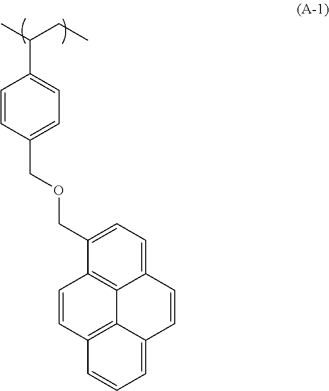

The content of the structural unit A in the polymer P is, for example, greater than or equal to 5 mol % and may be greater than or equal to 7 mol %, greater than or equal to 10 mol %, greater than or equal to 15 mol %, or greater than or equal to 20 mol %. The upper limit value of the content of the structural unit A, which is not particularly limited, is, for example, 65 mol %.

The polymer P may further contain another structural unit other than the structural unit A. Examples of the other structural unit include a structural unit B1 derived from styrenes and not having the group G and a structural unit B2 derived from stilbenes and not having the group G. In the present specification, the structural unit B1 may be simply called the structural unit B1 derived from styrenes. The structural unit B2 may be simply called the structural unit B2 derived from stilbenes. The polymer P contains, for example, at least one structural unit B selected from the group consisting of the structural unit B1 derived from styrenes and the structural unit B2 derived from stilbenes. The polymer P may contain the structural unit B1 derived from styrenes.

The structural unit B is represented by, for example, Formula (2) below:

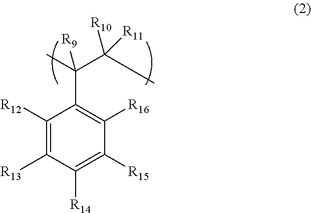

In Formula (2), R₉ to R₁₆ are mutually independently a group containing at least one atom selected from the group consisting of H, B, C, N, O, F, Si, P, S, Cl, Br, and I and other than the group G having nonlinear light absorption characteristics.

R₉ to R₁₆ may be mutually independently a hydrogen atom, a halogen atom, a hydrocarbon group, a halogenated hydrocarbon group, a group containing an oxygen atom, a group containing a nitrogen atom, a group containing a sulfur atom, a group containing a silicon atom, a group containing a phosphorus atom, or a group containing a boron atom. Examples of these groups include those described above for R₁ to R₈.

At least one selected from the group consisting of R₁₂ to R₁₆ may contain a leaving group or a polar functional group that can be utilized for a nucleophilic substitution reaction. Examples of the leaving group include a halogen group. Examples of the polar functional group include a hydroxy group, an amino group, and a thiol group.

Specific examples of the structural unit B include a structural unit B-1 represented by Formula (B-1) to a structural unit B-8 represented by Formula (B-8) below:

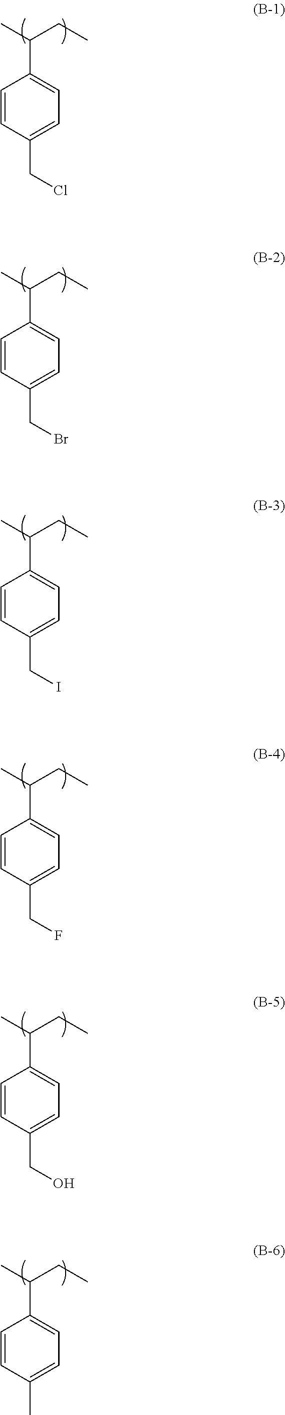

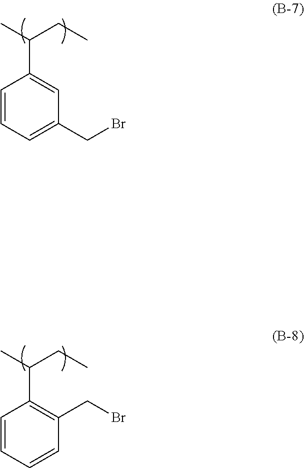

The content of the structural unit B in the polymer P, which is not particularly limited, is, for example, less than or equal to 70 mol % and may be less than or equal to 60 mol %, less than or equal to 50 mol %, less than or equal to 40 mol %, less than or equal to 30 mol %, less than or equal to 20 mol %, or less than or equal to 10 mol %, The lower limit value of the content of the structural unit B, which is not particularly limited, is, for example, 1 mol %.

The polymer P may have at least one selected from the group consisting of a carbazole skeleton and a naphthalene skeleton in a side chain. In other words, the polymer P may contain a structural unit C, as another structural unit other than the structural unit A, having at least one selected from the group consisting of a carbazole skeleton and a naphthalene skeleton in a side chain. Note that in the polymer P, the carbazole skeleton or the naphthalene skeleton may be contained in a main chain. However, the polymer P containing the carbazole skeleton or the naphthalene skeleton in the main chain may show one-photon absorption characteristics against the light with a wavelength in a range of 390 nm to 420 nm.

The structural unit C is represented by, for example, Formula (3) below:

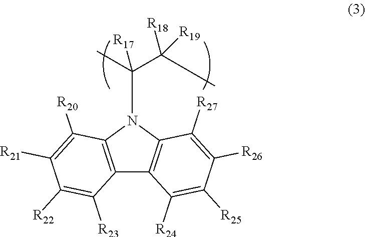

In Formula (3), R₁₇ to R₂₇ mutually independently contain at least one atom selected from the group consisting of H, B, C, N, O, F, Si, P, S, Cl, Br and I.

R₁₇ to R₂₇ may be mutually independently a hydrogen atom, a halogen atom, a hydrocarbon group, a halogenated hydrocarbon group, a group containing an oxygen atom, a group containing a nitrogen atom, a group containing a sulfur atom, a group containing a silicon atom, a group containing a phosphorus atom, or a group containing a boron atom. Examples of these groups include those described above for R₁ to R₈.

Specific examples of the structural unit C include a structural unit C-1 represented by Formula (C-1) to a structural unit C-17 represented by Formula (C-17) below:

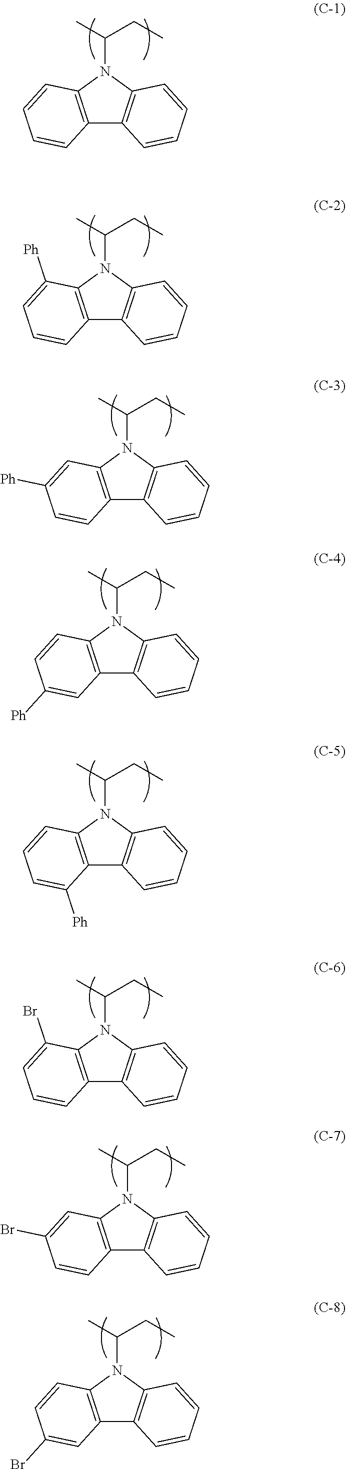

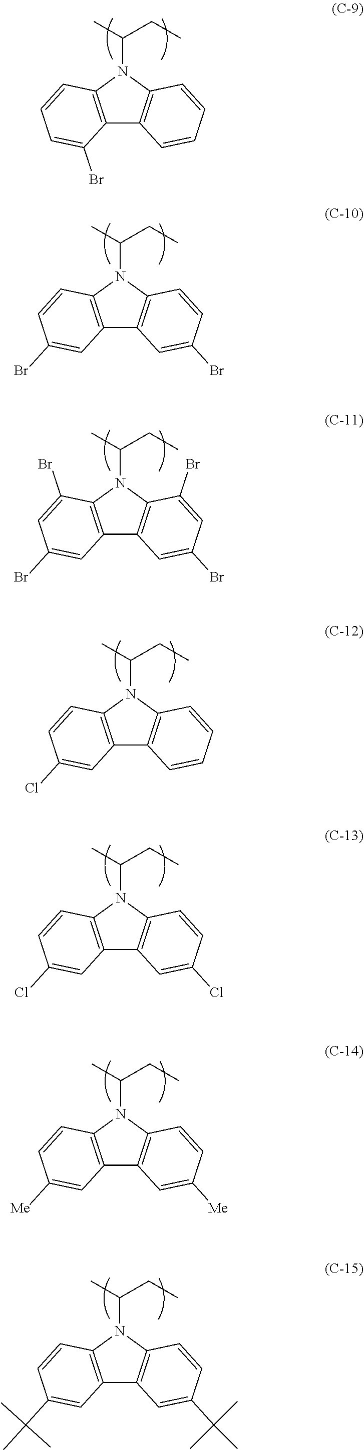

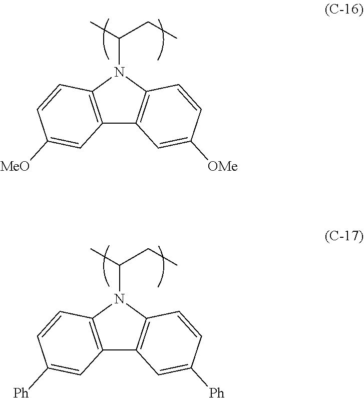

The content of the structural unit C in the polymer P, which is not particularly limited, is, for example, greater than or equal to 10 mol % and may be greater than or equal to 35 mol %, greater than or equal to 50 mol %, greater than or equal to 70 mol %, or greater than or equal to 90 mol %. The upper limit value of the content of the structural unit C, which is not particularly limited, is, for example, 95 mol %.

The polymer P contains, for example, at least one selected from the group consisting of the structural unit A represented by Formula (1), the structural unit B represented by Formula (2), and the structural unit C represented by Formula (3) above. The polymer P may contain the structural units A to C. As an example, the polymer P may be a random copolymer represented by Formula (5) below:

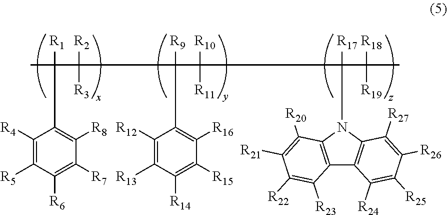

In Formula (5), R₁ to R₂₇ are the same as those described above for Formula (1), Formula (2), and Formula (3). The letters x, y, and z are mutually independently any integer.

In the polymer P, the number x of the structural unit A, the number y of the structural unit B, and the number z of the structural unit C may satisfy 0.35≤z/(x+y+z) or satisfy 0.07≤x/(x+y+z)≤0.65.

As described above, the polymer P is typically a random copolymer. However, the polymer P may be a block copolymer, a graft copolymer, or the like.

Specific examples of the polymer P include a random copolymer P1 represented by Formula (P1) below:

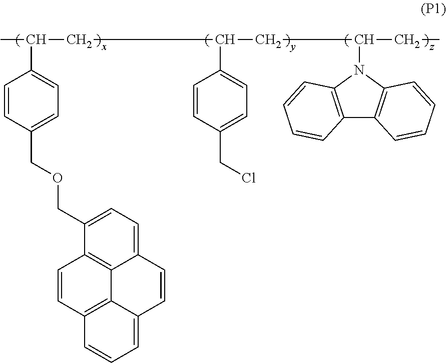

In Formula (P1), x, y, and z are mutually independently any integer.

As described above, the glass transition temperature of the polymer P is higher than or equal to 200° C. The polymer P having such a high glass transition temperature is thermally stable. There is a tendency that the recording layer 10 containing this polymer P can prevent the shape of a recording mark formed by the application of light from changing. That is, there is a tendency that the polymer P can improve the stability of the shape of the recording mark. On the other hand, if the glass transition temperature of the polymer P is too high, the recording sensitivity of the recording layer 10 may decrease. Thus, from the viewpoint of achieving both thermal stability and recording sensitivity, the glass transition temperature of the polymer P is, for example, higher than or equal to 200° C. and lower than or equal to 300° C. The glass transition temperature of the polymer P may be higher than or equal to 200° C. and lower than or equal to 250° C.

The glass transition temperature of the polymer P can be identified by the following method. First, for the polymer P, thermal gravity-differential thermal analysis (TG-DTA) measurement is performed on the following conditions to create a DTA curve. The glass transition temperature can be identified from an inflection point of thermal capacity in the DTA curve.

### Measurement Conditions

Atmosphere: nitrogen atmosphere
Measurement range: 25° C. to 400° C.
Heating rate: 15° C./min

There is a tendency that when the weight average molecular weight of the polymer P is high to some extent, the recording layer 10 can be easily made into a film. On the other hand, if the weight average molecular weight of the polymer P is too high, the solubility of the polymer P may decrease, which may make it difficult to make the recording layer 10 into a film by a coating method. Thus, the weight average molecular weight of the polymer P may be greater than or equal to 4,000 and less than or equal to 100,000. The weight average molecular weight of the polymer P may be greater than or equal to 4,000 and less than or equal to 50,000.

The polymer P is high in, for example, a transmittance of the light with a wavelength in a range of 390 nm to 420 nm, a refractive index, and the glass transition temperature. In particular, the polymer P having a carbazole skeleton or a naphthalene skeleton in a side chain easily adjusts the transmittance, the refractive index, and the glass transition temperature to be high. However, there is a tendency that it is difficult to bond the group G having nonlinear light absorption characteristics to the carbazole skeleton or the naphthalene skeleton. Thus, when the polymer P is synthesized, a copolymer of vinylcarbazoles and styrenes, a copolymer of vinylcarbazoles and stilbenes, a copolymer of naphthalenes and styrenes, a copolymer of naphthalenes and stilbenes, or the like may be utilized as a precursor polymer. In these copolymers, by introducing the group G having nonlinear light absorption characteristics to a structural unit derived from styrenes or stilbenes, the polymer P can be simply synthesized. Styrenes and stilbenes not only can be easily bonded to the group G having nonlinear light absorption characteristics but also moderately have reactivity for a copolymerization reaction. There is a tendency that the polymer P containing the structural unit derived from styrenes or stilbenes has an excellent transmittance of the light with a wavelength in a range of 390 nm to 420 nm and has a high refractive index and a high glass transition temperature.

The method for synthesizing the polymer P is not particularly limited. The polymer P may be synthesized by reacting a nonlinear light absorption dye with the precursor polymer. The polymer P may be synthesized by preparing a monomer having the group G having nonlinear light absorption characteristics in advance and polymerizing a monomer group containing the monomer. As the reaction of bonding the nonlinear light absorption dye to the precursor polymer, a nucleophilic substitution reaction reacting a leaving group and a polar functional group with each other, a cross-coupling reaction using a transition metal catalyst or the like, or the like can be utilized. Examples of the leaving group include a halogen group. Examples of the polar functional group include a hydroxy group, an amino group, and a thiol group. As an example, the polymer P may be synthesized by a reaction of the precursor polymer containing a structural unit derived from styrenes or stilbenes and having the leaving group and the nonlinear light absorption dye having the polar functional group. The polymer P may be synthesized by a reaction of the precursor polymer containing a structural unit derived from styrenes or stilbenes and having the polar functional group and the nonlinear light absorption dye having the leaving group.

The following describes an example of a method for synthesizing the random copolymer P1 described above. First, using a radical initiator, vinylcarbazole and 4-(chloromethyl)styrene are copolymerized to synthesize a precursor polymer. This reaction is represented by the following reaction formula:

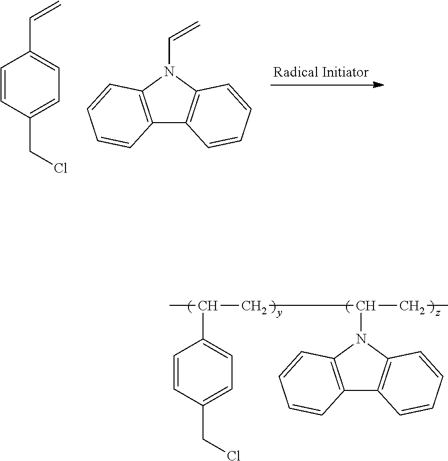

In the above precursor polymer, there is a tendency that the larger the number z of the structural unit derived from vinylcarbazole, the more the refractive index and the glass transition temperature improve, and the more the solubility to a solvent decreases. Thus, the composition of the precursor polymer can be adjusted as appropriate in accordance with the aimed refractive index, glass transition temperature, and solubility. The composition of the precursor polymer can be controlled by, for example, the ratio of the preparation amounts of vinylcarbazole and 4-(chloromethyl)styrene.

Next, the precursor polymer and 1-(hydroxymethyl)pyrene as a pyrene derivative functioning as a nonlinear light absorption dye are reacted with each other. In this reaction, a base may be used as needed. With this reaction, a chlorine atom of a structural unit derived from 4-(chloromethyl)styrene is replaced by a hydroxy group as a polar functional group of the nonlinear light absorption dye, and thus the random copolymer P1 can be obtained.

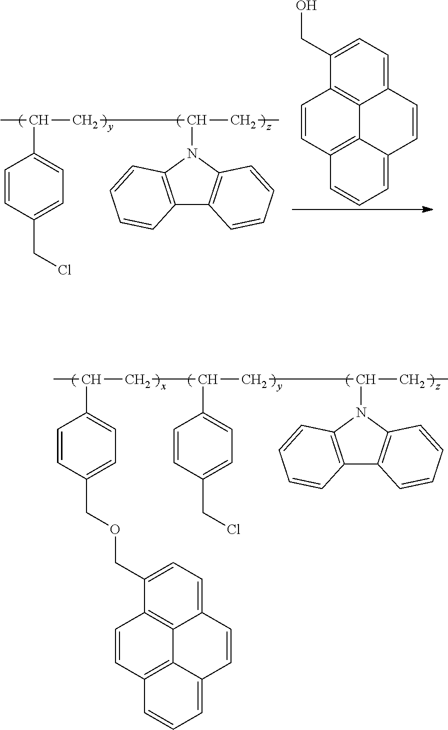

The random copolymer P1 is soluble to a solvent such as a chlorobenzene or THF. Thus, by preparing a coating liquid containing the random copolymer P1 and forming a film by utilizing spin coating or the like, the recording layer 10 can be easily produced.

The recording layer 10, for example, contains the polymer P as a main component. The “main component” means a component contained most in terms of weight ratio in the recording layer 10. The recording layer 10, for example, consists essentially of the polymer P. “Consisting essentially of . . . ” means excluding other components that change the substantial features of the material referred to. However, the recording layer 10 may contain impurities other than the polymer P.

The recording layer 10 is, for example, a thin film having a thickness of greater than or equal to 1 nm and less than or equal to 100 m. However, the thickness of the recording layer 10 may be greater than 100 m.

The transmittance of light with a wavelength of 405 nm in the recording layer 10 is, for example, greater than or equal to 90% and may be greater than or equal to 95% or greater than or equal to 99%. There is a tendency that the higher the transmittance of the light with a wavelength of 405 nm, the smaller the linear light absorption at the wavelength of the recording layer 10, and the better the recording sensitivity thereof.

The above transmittance can be measured by a method conforming to the prescription of JIS K0115: 2004 using the recording layer 10 itself as a sample to be measured. Specifically, first, light having a wavelength of 405 nm is applied to the recording layer 10. The application of light is performed such that the light travels in the thickness direction of the recording layer 10. As a light source, one emitting light with photon density that causes almost no nonlinear light absorption by the polymer P is used. Next, from the light having passed through the recording layer 10, an absorbance A of the recording layer 10 for a wavelength of 405 nm is read. Based on the absorbance A, a transmittance T of the light with a wavelength of 405 nm in the recording layer 10 can be calculated by Expression (I) below:

$$Transmittance T = {10}^{( - A )} \qquad ( I )$$

In the above measurement, when the recording layer 10 is a thin film, an accurate absorbance A may not be able to be measured by the occurrence of film interference. In this case, the transmittance may be calculated by measuring an extinction coefficient using an ellipsometer. The material of the recording layer 10 may be dissolved in an appropriate solvent, and the transmittance may be calculated using a value of absorbance measured in the state of a solution.

The refractive index of the recording layer 10 may be greater than or equal to 1.65, greater than or equal to 1.68, or greater than or equal to 1.70. The higher the refractive index of the recording layer 10, the more easily the difference from the refractive index of the adjacent dielectric layer 20 can be increased. In the recording layer 10 and the dielectric layer 20, when the difference in the refractive index is large, the reflectance of light at the interface between the recording layer 10 and the dielectric layer 20 rises. There is a tendency that when the reflectance of light at the interface is high, a good reproduction signal can be obtained from the recording medium 100. The upper limit value of the refractive index of the recording layer 10, which is not particularly limited, is, for example, 1.90. In the present specification, the refractive index of the recording layer 10 is a value for the light with a wavelength of 405 nm and can be measured using an ellipsometer.

The above group G having nonlinear light absorption characteristics may have small linear light absorption and have an appropriate nonlinear light absorption amount at the record reproduction wavelength. For example, when a laser with a wavelength of 405 nm is used for record reproduction, the two-photon absorption cross section of the group G having nonlinear light absorption characteristics may be greater than 1 GM, greater than or equal to 10 GM, greater than or equal to 20 GM, or greater than or equal to 100 GM. The upper limit value of the two-photon absorption cross section, which is not particularly limited, is, for example, 1,000 GM. The two-photon absorption cross section can be measured by, for example, the Z scan method described in J. Opt. Soc. Am. B, 2003, Vol. 20, p. 529. using a compound having the same structure as that of the group G having nonlinear light absorption characteristics as a sample to be measured. The Z scan method is being widely used as a method for measuring nonlinear optical constants. In the Z scan method, near a focus at which a laser beam is focused, the sample to be measured is moved along the application direction of the beam. In this process, a change in the amount of light having passed through the sample to be measured is recorded. In the Z scan method, the power density of incident light changes in accordance with the position of the sample to be measured. Thus, when the sample to be measured undergoes nonlinear light absorption, when the sample to be measured is positioned near the focus of the laser beam, the amount of the transmitted light attenuates. The two-photon absorption cross section can be calculated by performing fitting about a change in the amount of the transmitted light against a theoretical curve predicted from the intensity of the incident light, the thickness of the sample to be measured, the concentration of the compound in the sample to be measured, and the like. As an example, the two-photon absorption cross section of a pyrene derivative is about 50 GM to 300 GM.

The two-photon absorption cross section may be a calculated value by computational chemistry. Some methods for estimating the two-photon absorption cross section by computational chemistry have been developed. For example, a calculated value of the two-photon absorption cross section can be calculated based on, for example, the second-order nonlinear response theory described in J. Chem. Theory Comput. 2018, Vol. 14, p. 807.

The group G having nonlinear light absorption characteristics may utilize a nonlinear light absorption phenomenon by excited state absorption.

Note that in conventional recording layers, normally, a nonlinear light absorption dye as a low molecular weight compound is dispersed in resin. In such a configuration, the nonlinear light absorption dye may diffuse from the recording layer to another layer such as a dielectric layer. Furthermore, during production of the recording medium, when the dielectric layer is produced on the recording layer by utilizing a coating method, the dye may be eluted out of the recording layer. The elution of the dye is particularly conspicuous when the molecular weight of the dye is low.

In the present embodiment, in the recording layer 10, the polymer P contains the group G having nonlinear light absorption characteristics. There is a tendency that the polymer P is less likely to diffuse from the recording layer 10 to the dielectric layer 20 or the like. That is, in the present embodiment, the diffusion of the polymer P functioning as a nonlinear light absorption material is prevented. With this, there is a tendency, for example, that the stability of the intensity of reflected light at the interface between the recording layer 10 and the dielectric layer 20 improves. Thus, the recording medium 100 has high performance in recording and reading of information and can easily maintain this performance. In the present embodiment, there is a tendency that the polymer P is less likely to be eluted even when the dielectric layer 20 is produced on the recording layer 10 by utilizing a coating method. Thus, the present embodiment can produce the recording medium 100 having a multilayer structure by a simple coating process.

### Dielectric Layer

In the dielectric layer 20, for example, a material that can adjust the refractive index difference from the recording layer 10 to an appropriate value and has high light transmittance at the record reproduction wavelength is used. The dielectric layer 20, by adjusting its thickness, can appropriately adjust the interlayer distance between the recording layers 10.

The refractive index difference between the recording layer 10 and the dielectric layer 20 is, for example, about 0.2. It is known that when the refractive index of the recording layer 10 is represented by n1 and the refractive index of the dielectric layer 20 is represented by n2, the reflectance at the interface between the recording layer 10 and the dielectric layer 20 is about a value calculated by ((n2−n1)/(n2+n1))². That is, when the refractive index of the recording layer 10 is 1.65 and the refractive index of the dielectric layer 20 is 1.45, the reflectance at the interface between these layers is about 0.004.

The dielectric layer 20 contains, for example, a polymer material. In general, the refractive index of the polymer material for use in the dielectric layer 20 is about 1.4 to 1.6 and in particular about 1.45 to 1.5. Thus, when the refractive index of the recording layer 10 is higher than 1.65, the refractive index difference from the dielectric layer 20 is easily adjusted to be about 0.1 to 0.2. By adjusting the refractive index difference between the recording layer 10 and the dielectric layer 20 to the above range, the intensity of the reflected light at the interface can be improved, and good reproduction characteristics can be obtained.

Examples of the material of the dielectric layer 20 include cellulose acetate, acrylic resins, and methacrylic resins.

The thickness of the dielectric layer 20, which is not particularly limited, is, for example, greater than or equal to 5 nm and less than or equal to 100 m. However, the thickness of the dielectric layer 20 may be greater than 100 m.

### Method for Producing Recording Medium

The recording medium 100 can be produced by, for example, the following method. First, a resin material containing the polymer P is mixed with a solvent to produce a coating liquid. This coating liquid is coated to a base by a method such as spin coating, and the obtained coated film is dried to produce the recording layer 10 as a thin film.

Next, the dielectric layer 20 is formed on the recording layer 10. When the dielectric material 20 contains a resin material, first, the resin material is mixed with a solvent to produce a coating liquid. This coating liquid is coated onto the recording layer 10 by a method such as spin coating, the obtained coated film is dried, and thereby the dielectric layer 20 can be produced. Note that the coating liquid may contain a photosensitive monomer or the like, and the dielectric layer 20 may be produced by polymerizing the monomer through light or heat. The dielectric layer 20 may be produced by producing a thin film functioning as the dielectric layer 20 in advance and laminating the thin film onto the recording layer 10. As needed, the recording medium 100 can be obtained by alternately producing a plurality of recording layers 10 and a plurality of dielectric layers 20.

### Method for Using Recording Medium

The recording medium 100 of the present embodiment utilizes, for example, light having a wavelength in a short wavelength range. As an example, the recording medium 100 utilizes light having a wavelength of longer than or equal to 390 nm and shorter than or equal to 420 nm. The light utilized for the recording medium 100, for example, has high photon density near its focus. The power density of the light utilized for the recording medium 100 near its focus is, for example, greater than or equal to 0.1 W/cm² and less than or equal to 1.0×10²⁰ W/cm². The power density of this light near its focus may be greater than or equal to 1.0 W/cm², greater than or equal to 1.0×10² W/cm², or greater than or equal to 1.0×10⁵ W/cm². As a light source utilized for the recording medium 100, for example, a femtosecond laser such as a titanium sapphire laser or a pulsed laser having a pulse width of picoseconds to nanoseconds, such as a semiconductor laser, can be used.

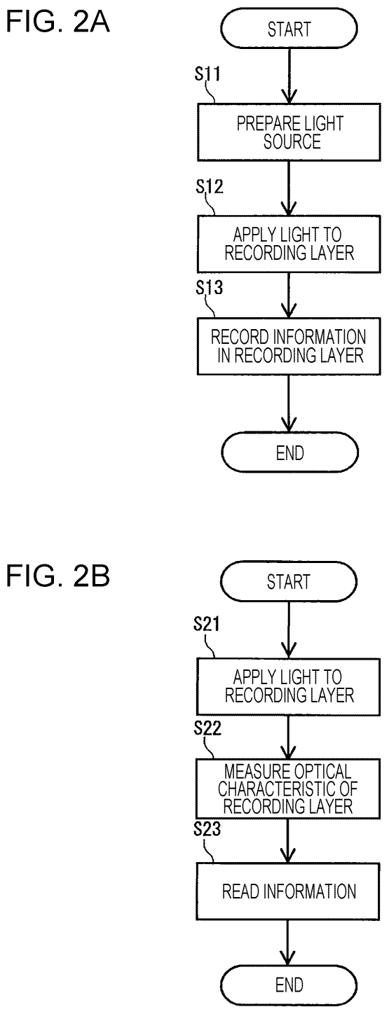

The following describes a method for recording information using the recording medium 100. FIG. 2A is a flowchart about the method for recording information using the recording medium 100. First, in Step S11, a light source emitting light having a wavelength of longer than or equal to 390 nm and shorter than or equal to 420 nm is prepared. As the light source, for example, a femtosecond laser such as a titanium sapphire laser or a pulsed laser having a pulse width of picoseconds to nanoseconds, such as a semiconductor laser, can be used. Next, in Step S12, the light from the light source is focused with a lens or the like to be applied to the recording layer 10 of the recording medium 100. Specifically, the light from the light source is focused with a lens or the like to be applied to a recording area of the recording medium 100. The NA (numerical aperture) of the lens for use in focusing is not particularly limited. As an example, a lens with an NA in a range of greater than or equal to 0.8 and less than or equal to 0.9 may be used. The power density of this light near its focus is, for example, greater than or equal to 0.1 W/cm² and less than or equal to 1.0×10²⁰ W/cm². The power density of this light near its focus may be greater than or equal to 1.0 W/cm², greater than or equal to 1.0×10² W/cm², or greater than or equal to 1.0×10⁵ W/cm². In the present specification, the recording area means a spot present in the recording layer 10 and capable of recording information by the application of light.

In the recording area to which the above light has been applied, a physical change or a chemical change occurs, thereby changing an optical characteristic of the recording area. For example, the intensity of the light reflected by the recording area, the reflectance of the light at the recording area, the absorptance of the light at the recording area, the refractive index of the light at the recording area, the light intensity of fluorescence emitted from the recording area, the light wavelength of fluorescence, or the like changes. As an example, the intensity of the light reflected by the recording area or the light intensity of fluorescence emitted from the recording area decreases. This can record information in the recording layer 10, or specifically, the recording area (Step S13).

The following describes a method for reading information using the recording medium 100. FIG. 2B is a flowchart about the method for reading information using the recording medium 100. First, in Step S21, light is applied to the recording layer 10 of the recording medium 100. Specifically, light is applied to the recording area of the recording medium 100. The light used in Step S21 may be the same as the light utilized for recording information in the recording medium 100 or different therefrom. Next, in Step S22, an optical characteristic of the recording layer 10 is measured. Specifically, an optical characteristic of the recording area is measured. In Step S22, for example, as the optical characteristic of the recording area, the intensity of the light reflected by the recording area or the light intensity of fluorescence emitted from the recording area is measured. In Step S22, as the optical characteristic of the recording area, the reflectance of the light at the recording area, the absorptance of the light at the recording area, the refractive index of the light at the recording area, the light wavelength of fluorescence emitted from the recording area, or the like may be measured. Next in Step S23, information is read from the recording layer 10, or specifically, the recording area.

In the method for reading information, the recording area in which information has been recorded can be searched for by the following method. First, light is applied to a specific area of the recording medium. This light may be the same as the light utilized for recording information in the recording medium or different therefrom. Next, an optical characteristic of the area to which the light has been applied is measured. Examples of the optical characteristic include the intensity of the light reflected by the area, the reflectance of the light at the area, the absorptance of the light at the area, the refractive index of the light at the area, the light intensity of fluorescence emitted from the area, and the light wavelength of fluorescence emitted from the area. Based on the measured optical characteristic, whether the area to which the light has been applied is the recording area is determined. For example, it is determined that the area is the recording area when the intensity of the light reflected by the area is less than or equal to a specific value. On the other hand, it is determined that the area is not the recording area when the intensity of the light reflected by the area is greater than the specific value. Note that the method for determining whether the area to which the light has been applied is the recording area is not limited to the above method. For example, it may be determined that the area is the recording area when the intensity of the light reflected by the area is greater than a specific value. It may be determined that the area is not the recording area when the intensity of the light reflected by the area is less than or equal to the specific value. When it is determined that the area is not the recording area, the same operation is performed for another area of the recording medium. This can search for the recording area.

The method for recording information and the method for reading information using the recording medium 100 can be performed by, for example, a known recording apparatus. The recording apparatus includes, for example, a light source applying light to the recording area of the recording medium 100, a measuring device measuring the optical characteristic of the recording area, and a controller controlling the light source and the measuring device.

### EXAMPLES

The following describes the present disclosure in more detail with reference to examples. The following examples are by way of example, and the present disclosure is not limited to the following examples.

First, as materials of the recording layer, the following compounds A to F were prepared. Note that all the compounds A to E were random copolymers.

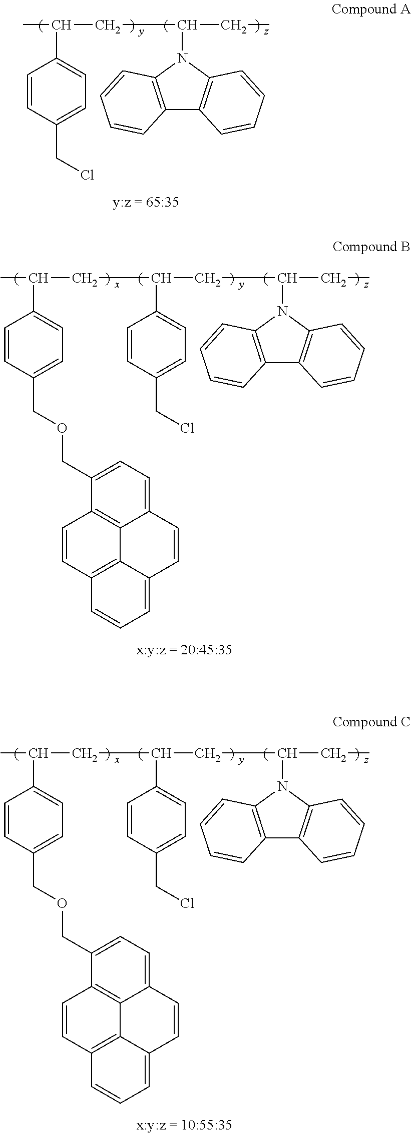

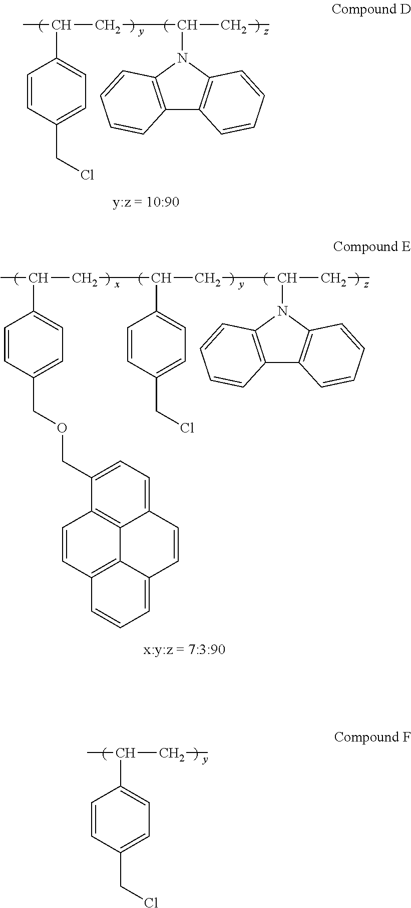

### Synthesis of Compounds A and D

The compounds A and D were synthesized as the following reaction formula in conformity with the method described in Macromolecules 2006, 39, 3140-3146. The compounds A and D were identified with ¹H-NMR.

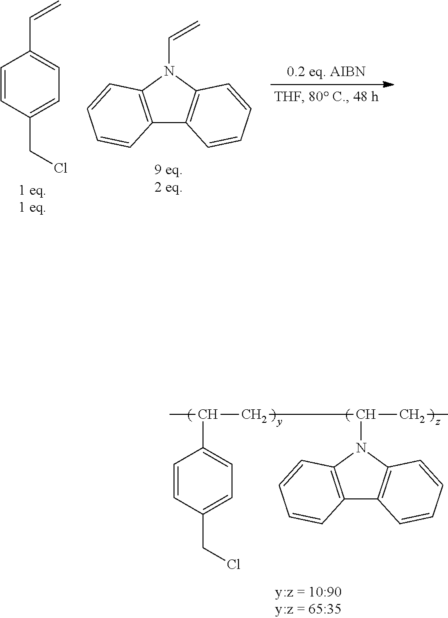

### Synthesis of Compound B

First, 1-(hydroxymethyl)pyrene (made by Tokyo Chemical Industry Co., Ltd.) was dissolved in tetrahydrofuran (THF, made by FUJIFILM Wako Pure Chemical Corporation), and an excess amount of potassium carbonate (made by FUJIFILM Wako Pure Chemical Corporation) and a small amount of N,N-dimethylformamide (DMF, made by made by FUJIFILM Wako Pure Chemical Corporation) were added thereto, and the mixture was heated and fluxed at 80° C. for 1 hour in a nitrogen atmosphere. A THF solution of the compound A was further added thereto, and the mixture was heated and fluxed at 80° C. for 48 hours with stirring. The weight of the added compound A was 0.5 time the weight of 1-(hydroxymethyl)pyrene. Next, the reaction solution, which had been naturally cooled to room temperature, was added to a large amount of methanol to obtain a white precipitate. The obtained solid was collected by filtration and was subjected to a washing operation. In the washing operation, ethanol, water, and diethyl ether were used in this order as washing liquids. The solid was dried in a vacuum to obtain the compound B. The compound B was identified with ¹H-NMR.

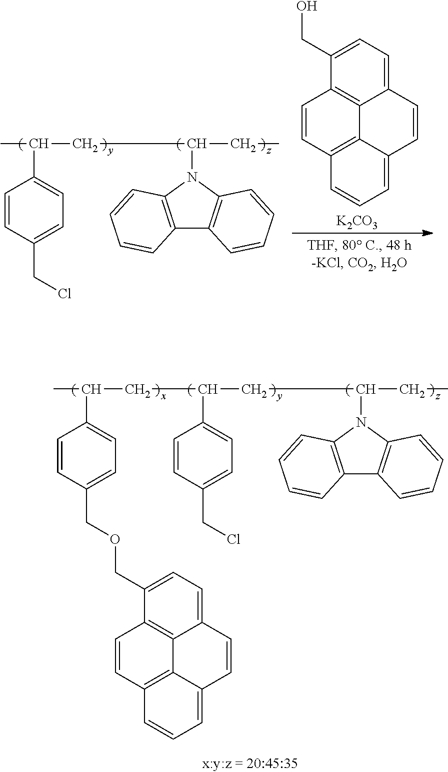

### Synthesis of Compound C

The compound C was synthesized in the same manner as for the compound B except that the weight of the added compound A was changed to the same value as the weight of 1-(hydroxymethyl)pyrene. The compound C was identified with ¹H-NMR.

### Synthesis of Compound E

The compound E was synthesized in the same manner as for the compound B except that the compound D was used instead of the compound A and the weight of the added compound D was changed to the same value as the weight of 1-(hydroxymethyl)pyrene. The compound E was identified with ¹H-NMR.

### Synthesis of Compound F

The compound F was synthesized in the same manner as for the compound A except that N-vinylcarbazole was not used. The compound F was identified with ¹H-NMR.

### Production of Recording Medium

### Example 1

First, a glass substrate with sides of 20 mm and a thickness of 1 mm was prepared. A solution containing the compound B was coated to the glass substrate by spin coating. The solution contained chlorobenzene (made by FUJIFILM Wako Pure Chemical Corporation) as a solvent. In the solution, the weight ratio of the compound B to chlorobenzene was 5% by mass. Spin coating was performed on the conditions of 3,000 rpm and 30 seconds. Next, the obtained coated film was dried at 80° C. for 30 minutes to produce a recording layer. Thus, a recording medium of Examples 1 was obtained.

### Example 2

A recording medium of Example 2 was produced in the same manner as in Example 1 except that the compound C was used instead of the compound B.

### Example 3

A recording medium of Example 3 was produced in the same manner as in Example 1 except that the compound E was used instead of the compound B.

### Comparative Example 1

A recording medium of Comparative Example 1 was produced in the same manner as in Example 1 except that the compound A was used instead of the compound B and 1-(hydroxymethyl)pyrene in 20% by mass with respect to the compound A was further added to the solution. In the recording layer of Comparative Example 1, 1-(hydroxymethyl)pyrene, which is a nonlinear light absorption dye, was dispersed in the compound A.

### Comparative Example 2

A recording medium of Comparative Example 2 was produced in the same manner as in Example 1 except that the compound D was used instead of the compound B and 1-(hydroxymethyl)pyrene in 16% by mass with respect to the compound D was further added to the solution. In the recording layer of Comparative Example 2, 1-(hydroxymethyl)pyrene, which is a nonlinear light absorption dye, was dispersed in the compound D.

### Comparative Example 3

A recording medium of Comparative Example 3 was produced in the same manner as in Example 1 except that the compound F was used instead of the compound B.

### Characteristics Evaluation

(1) Evaluation of Transmittance of Light with Wavelength of 405 nm in Recording Layer

For the examples and the comparative examples, the transmittance of light with a wavelength of 405 nm in the recording layer was evaluated by the method described above. Specifically, first, using a spectrophotometer and an ellipsometer, the characteristics of linear light absorption of the recording layer were evaluated. In the measurement with the spectrophotometer, a baseline was corrected with a measured value obtained when only glass was measured. From the obtained spectrum, the transmittance at a wavelength of 405 nm was calculated. In all the recording media of the examples and the comparative examples, the transmittance of the light with a wavelength of 405 nm in the recording layer was greater than or equal to 95%.

Note that in Examples 1 to 3 and Comparative Examples 1 and 2, the material of the recording layer was dissolved in chlorobenzene to produce a solution, and for the solution, measurement was performed using the spectrophotometer. Consequently, all of them had a maximum absorption wavelength of linear light absorption of 350 nm and had no absorption band of linear light absorption at a wavelength of 405 nm.

### (2) Evaluation of Refractive Index

For the examples and the comparative examples, using an ellipsometer, the refractive index of the recording layer was evaluated. Specifically, a refractive index at a wavelength of 405 nm was read from a spectrum obtained by the measurement. Note that in Comparative Example 3, the value of the refractive index of the recording layer was as low as 1.63. Thus, for Comparative Example 3, an evaluation of record reproduction characteristics and an evaluation of solvent resistance below were not preformed.

As can be seen from Table 1, in all Examples 1 to 3, the value of the refractive index of the recording layer was greater than or equal to 1.65. In these recording layers, for example, when the dielectric layer is produced on the recording layer, the difference in the refractive index from the dielectric layer is easily significantly adjusted. By significantly adjusting the difference in the refractive index, the reflectance of light at the interface between the recording layer and the dielectric layer can be raised. It is estimated that a good reproduction signal can be thereby obtained from the recording medium.

### (3) Evaluation of Glass Transition Temperature

For the compounds A to E, an evaluation of a glass transition temperature (Tg) was performed. Specifically, for the compounds A to E, using a powdery sample to be measured, thermal gravity-differential thermal analysis (TG-DTA) measurement was performed on the following conditions. Tg was identified from an inflection point of thermal capacity in a DTA curve.

### Measurement Conditions

Atmosphere: nitrogen atmosphere
Measurement range: 25° C. to 400° C.
Heating rate: 15° C./min

As can be seen from Table 1, in all Examples 1 to 3, the glass transition temperature of the used compound was higher than 200° C. It is estimated that the recording layers containing these compounds are thermally stable and can prevent the shape of a recording mark formed by the application of light from changing.

### (4) Evaluation of Record Reproduction Characteristics

### Recording Operation

First, for the recording media of the examples and the comparative examples, a recording operation was performed. Specifically, pulsed light with a central wavelength of 405 nm, a peak power of 100 mW, and a repetitive frequency of 100 kHz was applied to the recording medium through a lens with an NA of 0.85. In this process, the application of the pulsed light was performed while the recording medium was translated at 10 m/sec. The pulse width of the pulsed light was adjusted to be between 10 nanoseconds and 1,000 nanoseconds.

### Reproduction Operation

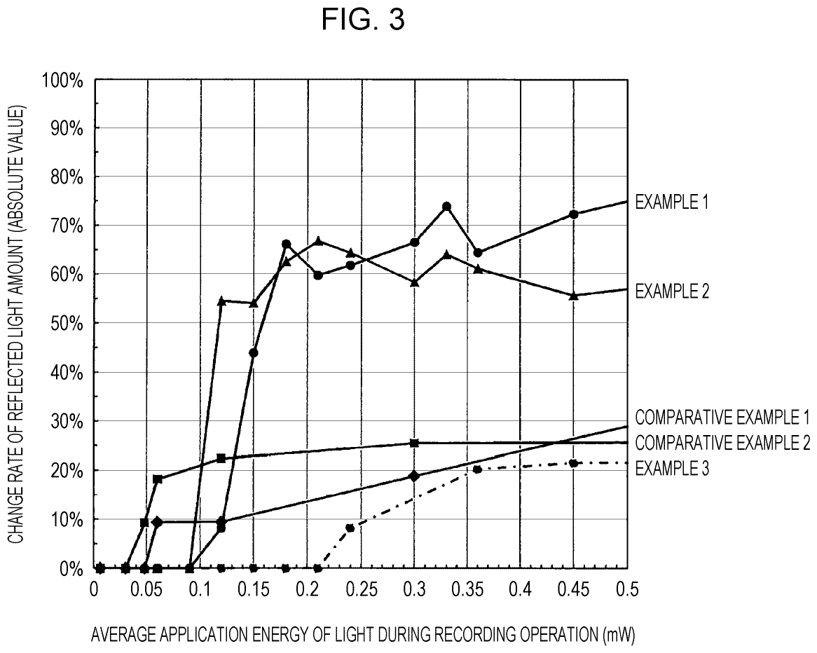

Next, for the recording medium on which the recording operation has been performed, a reproduction operation was performed. Specifically, light with a central wavelength of 405 nm, a peak power of 3 mW, a pulse width of 200 nanoseconds, and a repetitive frequency of 100 Hz was applied through a lens with an NA of 0.85 so as to cross a recording line of the recording layer to acquire reflected light signal intensity. Based on the measured result, a change rate of the reflected light signal intensity of the part on which the recording operation had been performed against the reflected light signal intensity of the part on which the recording operation had not been performed was calculated. FIG. 3 is a graph of the record reproduction characteristics of the recording media of the examples and the comparative examples. The vertical axis of this graph shows the calculated change rate. The horizontal axis thereof shows average application energy of light during the recording operation.

### Evaluation of Record Reproduction Characteristics

Next, a change rete of a reflected light amount when the average application energy is 0.03 mW was read from the graph in FIG. 3, and this change rate was assumed to be a change rate of the reflected light amount when reproducing light is applied. Furthermore, a change rate of the reflected light amount when the average application energy is 0.12 mW was read from the above graph, and this change rate was assumed to be a change rate of the reflected light amount when recording light is applied. Table 2 lists these change rates and the difference therebetween.

As can be seen from Table 2, in all Examples 1 to 3 and Comparative Examples 1 and 2, the change rate of the reflected light amount when the reproducing light is applied is 0%, with no significant change in the reflected light amount observed. Furthermore, in all Examples 1 and 2 and Comparative Examples 1 and 2, the change rate of the reflected light amount when the recording light is applied is greater than 0%, with a change in the reflected light amount observed. It can be seen from these results that in Examples 1 and 2 and Comparative Examples 1 and 2, a record reproduction operation for the recording medium can be performed by using the light with an average application energy of 0.03 mW as the reproducing light and using the light with an average application energy of 0.12 mW as the recording light.

On the other hand, in Example 3, the change rate of the reflected light amount when the average application energy is 0.12 mW is 0%, with no significant change in the reflected light amount observed. It can be seen from this result that in the recording medium of Example 3, the record reproduction operation cannot be performed when the light with an average application energy of 0.12 mW is used as the recording light. However, it can be seen from the graph in FIG. 3 that the record reproduction operation can be performed for the recording medium of Example 3 by using light with an average application energy of greater than or equal to 0.21 mW is used as the recording light.

### (5) Evaluation of Solvent Resistance

For the examples and the comparative examples, the solvent resistance of the recording layer was evaluated by the following method. First, 1 ml of a solvent was dropped onto the recording layer and was spin coated. As the solvent, assuming a solvent for a coating liquid for producing the dielectric layer, diacetone alcohol was used. Spin coating was performed on the conditions of 3,000 rpm and 30 seconds. Before and after dropping the solvent, an absorption spectrum of the recording layer was measured. Measurement of the absorption spectrum was performed in the same manner as in (1) above. A light absorptance at 350 nm, which is the maximum absorption wavelength of the nonlinear light absorption dye or the group having nonlinear light absorption, was read from the obtained spectrum to calculate a reduction rate of the light absorptance before and after dropping the solvent. Table 3 lists the results.

As can be seen from Table 3, in Comparative Examples 1 and 2, in which the nonlinear light absorption dye is dispersed in a polymer binder, the dye was eluted out of the recording layer due to dropping of the solvent, and light absorption at the maximum absorption wavelength of the dye decreased by 50% to 100%. On the other hand, when the compound B, C, or E, which corresponds to the polymer P containing the group having nonlinear light absorption characteristics is used for the recording layer, an absorptance change at the maximum absorption wavelength before and after dropping the solvent was significantly reduced. This result indicates that using the polymer P containing the group having nonlinear light absorption characteristics has improved the solvent resistance of the recording layer and has prevented the elution of the dye from the recording layer.

TABLE 1

| | | | | | Characteristics of recording | | |
|---|---|---|---|---|---|---|---|
| | | | | | layer or compound | | |
| | Material of | Composition of compound | | | Refractive | Glass transition | |
| | recording | x | y | z | index | temperature | Solvent |
| | layer | (mol %) | (mol %) | (mol %) | (405 nm) | (° C.) | resistance |
| Example 1 | Compound B | 20 | 45 | 35 | 1.68 | >200 | Good |
| Example 2 | Compound C | 10 | 55 | 35 | 1.68 | >200 | Good |
| Example 3 | Compound E | 7 | 3 | 90 | 1.72 | >200 | Good |
| Comparative | Compound A | 0 | 65 | 35 | 1.76 | 150 | Bad |
| Example 1 | with dye | | | | | | |
| | dispersed | | | | | | |
| Comparative | Compound D | 0 | 10 | 90 | 1.78 | >200 | Bad |
| Example 2 | with dye | | | | | | |
| | dispersed | | | | | | |
| Comparative | Compound F | 0 | 100 | 0 | 1.63 | — | — |
| Example 3 | | | | | | | |

TABLE 2

| | Change rate of reflected light amount | | Difference in | |
|---|---|---|---|---|
| | Reproducing | Recording | change rate of | |
| | light | light | reflected light | |
| | (0.03 mW) | (0.12 mW) | amount | Remark |
| Example 1 | 0% | 8% | 8% | |
| Example 2 | 0% | 55% | 55% | |
| Example 3 | 0% | 0% | 0% | Recording |
| | | | | operation is |
| | | | | possible with |
| | | | | recording light |
| | | | | with average |
| | | | | application |
| | | | | energy of greater |
| | | | | than or equal to |
| | | | | 0.21 mW |
| Comparative | 0% | 22% | 22% | |
| Example 1 | | | | |
| Comparative | 0% | 10% | 10% | |
| Example 2 | | | | |

TABLE 3

| | Reduction rate of |
|---|---|
| | light absorptance |
| | before and after |
| | dropping solvent |
| | (350 nm) |
| Example 1 | 20% |
| Example 2 | 15% |
| Example 3 | 6% |
| Comparative | 100% |
| Example 1 | |
| Comparative | 50% |
| Example 2 | |

The recording medium of the present disclosure can be utilized for uses such as three-dimensional optical memories.

What is claimed is:

1. A recording medium comprising a recording layer containing a polymer, wherein
the polymer contains a group having nonlinear light absorption characteristics and has a glass transition temperature of higher than or equal to 200° C.

2. The recording medium according to claim 1, wherein a transmittance of light with a wavelength of 405 nm in the recording layer is greater than or equal to 95%.

3. The recording medium according to claim 1, wherein a refractive index of the recording layer is greater than or equal to 1.65.

4. The recording medium according to claim 1, wherein the polymer has at least one selected from the group consisting of a carbazole skeleton and a naphthalene skeleton in a side chain.

5. The recording medium according to claim 1, wherein the polymer contains at least one selected from the group consisting of a structural unit derived from styrenes and a structural unit derived from stilbenes.

6. The recording medium according to claim 1, wherein the polymer contains at least one selected from the group consisting of a structural unit A represented by Formula (1) below, a structural unit B represented by Formula (2) below, and a structural unit C represented by Formula (3) below: 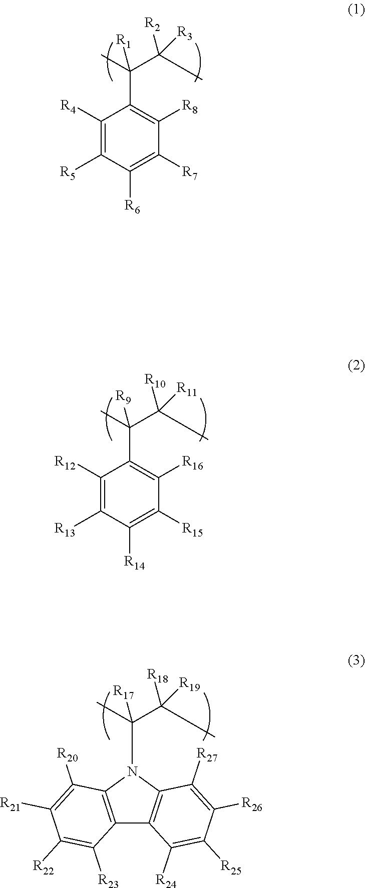
wherein in Formula (1) above, R₁ to R₈ mutually independently contain at least one atom selected from the group consisting of H, B, C, N, O, F, Si, P, S, Cl, Br, and I; and
at least one selected from the group consisting of R₄ to R₈ contains a group having nonlinear light absorption characteristics,
in Formula (2) above, R₉ to R₁₆ are mutually independently a group containing at least one atom selected from the group consisting of H, B, C, N, O, F, Si, P, S, Cl, Br, and I and other than a group having nonlinear light absorption characteristics, and
in Formula (3) above, R₁₇ to R₂₇ mutually independently contain at least one atom selected from the group consisting of H, B, C, N, O, F, Si, P, S, Cl, Br, and I.

7. The recording medium according to claim 6, wherein in the polymer, a number x of the structural unit A, a number y of the structural unit B, and a number z of the structural unit C satisfy 0.35≤z/(x+y+z).

8. The recording medium according to claim 6, wherein in the polymer, a number x of the structural unit A, a number y of the structural unit B, and a number z of the structural unit C satisfy 0.07≤x/(x+y+z)≤0.65.

9. The recording medium according to claim 6, wherein in Formula (1) above, at least one selected from the group consisting of R₄ to R₈ is represented by Formula (4) below:
-L-R_{A} (4)
wherein in Formula (4) above, L is a linking group containing at least one atom selected from the group consisting of C, N, O, and S; and R_{A} is a group having a pyrene skeleton.

10. A method for recording information comprising:
preparing a light source emitting light having a wavelength of longer than or equal to 390 nm and shorter than or equal to 420 nm; and
focusing the light from the light source and applying the light to the recording layer of the recording medium according to claim 1.

11. A method for reading information recorded by the method of recording according to claim 10, the method of reading comprising:
measuring an optical characteristic of the recording layer by applying light to the recording layer of the recording medium; and
reading information from the recording layer.
